(19) United States
(12) Patent Application Publication
(10) Pub. No.: US 2005/0162350 A1
(43) Pub. Date: Jul. 28, 2005

(54) Method of driving a plasma display panel

(76) Inventor: Jung Gwan Han, Gumi-si (KR)

Correspondence Address: MCKENNA LONG & ALDRIDGE LLP, 1900 K STREET, NW, WASHINGTON, DC, 20006, US

(21) Appl. No.: 10/979,763

(22) Filed: Nov. 3, 2004

(30) Foreign Application Priority Data
Nov. 3, 2003 (KR) 10-2003-0077274

(51) Int. Cl. G09G 3/28

(52) U.S. Cl. 345/63

(57) ABSTRACT

The present invention relates to a plasma display panel, and more particularly, to a method of driving a plasma display panel. According to an embodiment of the present invention, The method of driving the plasma display panel includes the steps of applying a first erase ramp waveform to scan electrode lines during an erase period of at least one selective writing sub-field among the plurality of the selective writing sub-fields, for erasing wall charges generated by a discharge, and applying a second erase ramp waveform to sustain electrode lines alternately with the first erase ramp waveform during the erase period. Therefore, as wall charges can be erased sufficiently during the erase period of the selective writing sub-fields, a discharge can be generated stably in subsequent sub-fields. Particularly, a discharge can be generated stably at high temperature.

This Nonprovisional application claims priority under 35 U.S.C. § 119(a) on Patent Application No. 10-2003-0077274 filed in Korea on Nov. 3, 2003, the entire contents of which are hereby incorporated by reference.

### BACKGROUND OF THE INVENTION

1. Field of the Invention

The present invention relates to a plasma display panel, and more particularly, to a method of driving a plasma display panel.

2. Description of the Background Art

A plasma display panel (hereinafter, referred to as a ‘PDP’) is adapted to display an image including characters or graphics by light-emitting phosphors with ultraviolet of 147 nm generated during the discharge of a gas such as He+Xe, Ne+Xe or He+Ne+Xe. This PDP can be easily made thin and large, and it can provide greatly increased image quality with the recent development of the relevant technology. Particularly, a three-electrode AC surface discharge type PDP has advantages of lower driving voltage and longer product lifespan as a voltage necessary for discharging is lowered by wall charges accumulated on a surface upon discharging and electrodes are protected from sputtering caused by discharging.

FIG. 1 is a perspective view illustrating the construction of a discharge cell of a three-electrode AC surface discharge type PDP in a prior art.

Referring to FIG. 1, the discharge cell of the three-electrode AC surface discharge type PDP includes a scan electrode 30Y and a sustain electrode 30Z which are formed on the bottom surface of an upper substrate 10, and an address electrode 20X formed on a lower substrate 18.

The scan electrode 30Y includes a transparent electrode 12Y, and a metal bus electrode 13Y which has a line width smaller than that of the transparent electrode 12Y and is disposed at one edge side of the transparent electrode. The sustain electrode 30Z includes a transparent electrode 12Z, and a metal bus electrode 13Z which has a line width smaller than that of the transparent electrode 12Z and is disposed at one side edge of the transparent electrode. The transparent electrodes 12Y, 12Z, which are typically made of ITO (indium tin oxide), are formed on the bottom surface of the upper substrate 10. The metal bus electrodes 13Y, 13Z, which are typically made of chrome (Cr), are formed on the transparent electrodes 12Y, 12Z, and serve to reduce a voltage drop caused by the transparent electrodes 12Y, 12Z having high resistance. On the bottom surface of the upper substrate 10 in which the scan electrodes 30Y and the sustain electrodes 30Z are placed in parallel with each other are laminated an upper dielectric layer 14 and a protective layer 16. On the upper dielectric layer 14 are accumulated wall charges generated during plasma discharge. The protective layer 16 serves to protect the upper dielectric layer 14 from sputtering generated during the plasma discharge, and improve efficiency of secondary electron emission. Magnesium oxide (MgO) is typically used as the protective layer 16. The address electrodes 20X are formed in the direction in which they intersect the scan electrode 30Y and the sustain electrode 30Z. A lower dielectric layer 22 and barrier ribs 24 are formed on the lower substrate 18 in which the lower dielectric layer 22 is formed. The barrier ribs 24 are formed in parallel with the address electrodes 20X to physically divide the discharge cells, thus preventing ultraviolet and a visible ray generated by the discharge from leaking toward neighboring discharge cells. The phosphor layer 26 is excited with an ultraviolet generated during the plasma discharging to generate a visible light of any one of red, green and blue lights. An inert mixed gas such as He+Xe, Ne+Xe or He+Ne+Xe is injected into the discharge spaces of the discharge cells defined between the upper substrate 10 and the barrier ribs 24 and between the lower substrate 18 and the barrier ribs 24.

This three-electrode AC surface discharge type PDP is driven with one frame being divided into a plurality of sub-fields having a different number of emission in order to implement the gray scale of an image. Each of the sub fields is divided into a reset period for uniformly generating discharging, an address period for selecting a discharge cell, and a sustain period for implementing the gray level according to the number of discharging. If it is desired to display an image with 256 gray scales, a frame period (16.67 ms) corresponding to 1/60 seconds is divided into eight sub-fields SF1 to SF8, as shown in FIG. 2. Each of the sub-fields SF1 to SF8 is subdivided into a reset period, an address period and a sustain period. The reset period and the address period of each of the sub-fields SF1 to SF8 are the same every sub-field, whereas the sustain period and the frequency of its discharging number increase in the ratio of 2ⁿ (where, n=0,1,2,3,4,5,6,7) in each sub-field. As the sustain period becomes different in each sub-field as such, the gray scale of an image can be implemented.

A method of driving the PDP is mainly classified into a selective writing mode and a selective erasing mode depending on whether a discharge cell selected by an address discharge is light-emitted.

In the selective writing mode, the entire cells are turned off during the reset period, and on-cells to be turned on are selected during the address period. Further, in the selective writing mode, discharging of on-cells selected by an address discharge is maintained during the sustain period, so that an image is displayed.

In the selective erasing mode, the entire cells are turned on during the reset period, and off-cells to be turned off are selected during the address period. Moreover, in the selective erasing mode, discharging of on-cells except for the off-cells selected by the address discharge are maintained during the sustain period, so that an image is displayed.

The selective writing mode has an advantage in that the range of gray scale representation is wider than that of the selective erasing mode, but has a disadvantage in that an address period is longer than that of the selective erasing mode. On the contrary, the selective erasing mode has an advantage in that high-speed driving is possible, but has a disadvantage in that a contrast characteristic is worse than that of the selective writing mode since the entire cell are turned on during the reset period being a non-display period.

A driving method of a so-called “SWSE mode”, which has advantages better than those of the selective writing mode and the selective erasing mode, has been already disclosed. In this SWSE mode, one frame period includes a plurality of selective writing sub-fields in which on-cells are selected to display an image, and a plurality of selective erasing sub-fields in which off-cells are selected to display an image.

FIG. 3 shows a driving waveform of a PDP that is driven in the SWSE mode.

Referring to FIG. 3, one frame in a common SWSE mode includes a selective writing sub-field WSF having one or more sub-fields, and a selective erasing sub-field ESF having one or more sub-fields.

The selective writing sub-field WSF includes a m number (where, m is a positive integer greater than 0) of sub-fields SF1 to SFm. Each of the first to (m−1)^{th} sub-fields SF1 to SFm−1 except for the m^{th} sub-field SFm is divided into a reset period for uniformly forming a constant amount of wall charges in cells of the entire screen, a selective writing address period (hereinafter, referred to as ‘writing address period’) for selecting on-cells using a write discharge, a sustain period for causing a sustain discharge to occur in selected on-cells, and an erase period for erasing wall charges within cells after the sustain discharge. The m^{th} sub-field SFm being the last sub-field of the selective writing sub-field WSF is divided into a reset period, a writing address period and a sustain period.

In the reset period of the selective writing sub-field WSF, a ramp waveform RPSU of a rising tilt in which a voltage rises up to a set-up voltage Vsetup is simultaneously applied to all the scan electrode lines Y. At the same time, a voltage of 0V or a ground voltage GND is applied to the sustain electrode lines Z and the address electrode lines X. The ramp-up waveform RPSU causes a dark discharge to occur between the scan electrode lines Y and the address electrode lines X and between the scan electrode lines Y and the sustain electrode lines Z within the cells of the entire screen. Wall charges of the positive (+) polarity are accumulated on the address electrode lines X and the sustain electrode lines Z and wall charges of the negative (−) polarity are accumulated on the scan electrode lines Y, by means of the set-up discharge.

After the ramp-up waveform RPSU, a ramp-down waveform RPSD of a falling tilt that starts to fall from a voltage of the positive polarity lower than the set-up voltage Vsetup is applied to the scan electrode lines Y. At the same time, a DC bias voltage Dcbias is applied to the sustain electrode lines Z. A dark discharge is generated between the scan electrode lines Y and the sustain electrode lines Z due to a voltage difference between the ramp-down waveform RPSD and the DC bias voltage DCbias. Further, a dark discharge is generated between the scan electrode lines Y and the address electrode lines X during a period where the ramp-down waveform RPSD drops. The set-down discharge by the ramp-down waveform RPSD erases excessive wall charges that do not contribute to the address discharge among charges generated by the ramp-up waveform RPSU. That is, the ramp-down waveform RPSD serves to set an initial condition of a stabilized write address.

In the writing address period of the selective writing sub-field WSF, a writing scan pulse SWSCN which drops up to a writing scan voltage −Vyw of the negative polarity is sequentially applied to the scan electrode lines Y, and at the same time a write data pulse SWD is applied to the address electrode lines X so that the writing scan pulse SWSCN is synchronized. While a voltage difference between the writing scan pulse SWSCN and the write data pulse SWD and a wall voltage that is accumulated previously within a cell are added, a write discharge is generated in on-cells to which the write data pulse SWD is applied. The write discharge causes wall charges of the positive polarity to be accumulated on the scan electrode lines Y and wall charges of the negative polarity to be accumulated on the sustain electrode lines Z and the address electrode lines X. The wall charges formed thus serve to lower an external voltage for generating the sustain discharge during the sustain period, i.e., a sustain voltage.

In the sustain period of the selective writing sub-field WSF, sustain pulses SUSPy, SUSPz are alternately supplied to the scan electrode lines Y and the sustain electrode lines Z. Whenever the sustain pulses SUSPy, SUSPz are applied as such, a sustain discharge is generated in on-cells in which a write discharge is generated during the writing address period.

After the last sustain discharge is generated, during the erase period of the first to (m−1)^{th} sub-fields SF1 to SFm−1 except for the last sub-field SFm of the selective writing sub-field WSF, an erase ramp waveform ERS in which a voltage gradually rises up to a sustain voltage (Vs) is applied to the sustain electrode lines Z. The erase ramp waveform ERS causes the wall charges generated by the sustain discharge to be erased while generating a weak erase discharge in the on-cells. On the contrary, after the last sustain discharge is generated in the last sub-field SFm of the selective writing sub-field WSF, it is transferred to the first sub-field SFm+1 of the selective erasing sub-field ESF without any erase signal. Resultantly, the erase ramp waveform ERS or an erase voltage (or waveform) having this erase function is arranged in a corresponding sub-field only when a next sub-field is a selective writing sub-field.

The selective erasing sub-field ESF includes a n-m number (where, n is a positive integer greater than m) of sub-fields SFm+1 to SFn. Each of the (m+1)^{th} to n^{th} sub-fields SFm+1 to SFn is divided into a selective erase address period (hereinafter, referred to as ‘erase address period’) for selecting off-cells using an erase discharge, and a sustain period for generating a sustain discharge in on-cells.

In the address period of the selective erasing sub-field ESF, an erase scan pulse SESCN that falls up to an erase scan voltage −Vye of the negative polarity is applied to the scan electrode lines Y sequentially. At the same time, a selective erase data pulse SED that is synchronized with the erase scan pulse SESCN is applied to the address electrode lines X. As a voltage difference between the selective erase scan pulse SESCN of the negative polarity and the erase data pulse SED and a wall voltage in the on-cells that is maintained from a previous sub-field are added, an erase discharge is generated in the on-cells to which the selective erase data pulse SED is applied. The wall charges in the on-cells are erased by the erase discharge causes to the extent that a discharge is not generated though a sustain voltage is applied.

During the erase address period of the selective erasing sub-field ESF, a voltage of 0V or a ground voltage GND is applied to the sustain electrode lines Z.

In the sustain period of the selective erasing sub-field SEF, sustain pulses SUSPy, SUSPz are alternately applied to the scan electrode lines Y and the sustain electrode lines Z. Whenever the sustain pulses SUSPy, SUSPz are applied as such, a sustain discharge is generated in on-cells in which the erase discharge is not generated during the erase address period.

Meanwhile, in the PDP driven in the SWSE mode, after the last sustain discharge is generated, during the erase period of the first to (m−1)^{th} sub-fields SF1 to SFm−1 of the selective writing sub-field WSF except for the last sub-field SFm, the erase ramp waveform ERS in which a voltage gradually rises up to the sustain voltage (Vs) is applied to the sustain electrode lines Z. The wall charges generated by the sustain discharge are erased by the erase ramp waveform ERS, while a weak erase discharge is generated in the on-cells. However, an unstable discharge can be generated in next sub-fields because the wall charges are not erased sufficiently with the erase ramp waveform ERS only.

This will be below described in detail. If the last sustain pulse SUSPy is applied to the scan electrode lines Y of the (m−1)^{th} sub-field SFm−1, wall charges of the positive (+) polarity are formed on the scan electrode lines Y and wall charges of the negative (−) polarity are formed on the sustain electrode lines Z, as shown in FIG. 4a. Thereafter, the erase ramp waveform ERS in which a voltage gradually rises up to the sustain voltage (Vs) is applied to the sustain electrode lines Z. Accordingly, a weak erase discharge occurs between the sustain electrode lines Z and the scan electrode lines Y. The wall charges of the negative (−) polarity are insignificantly erased in the scan electrode lines Y and the wall charges of the positive (+) polarity are insignificantly erased even in the sustain electrode lines Z, by means of the weak erase discharge, as shown in FIG. 4b.

Next, in the reset period of the m^{th} sub-field SFm (the last SW sub-field), the ramp waveform RPSU of a rising tilt in which a voltage rises up to the set-up voltage Vsetup is applied to all the scan electrode lines Y at the same time. At the same time, a voltage of 0V or a ground voltage GND is applied to the sustain electrode lines Z and the address electrode lines X. The ramp-up waveform RPSU causes a reset discharge to occur between the scan electrode lines Y and the address electrode lines X and between the scan electrode lines Y and the sustain electrode lines Z within the cells of the entire screen. In this time, as erasing was not sufficiently performed in the erase period of the previous sub-field SFm−1, excessive wall charges of the negative (−) polarity are formed on the scan electrode lines Y and excessive wall charges of the positive (+) polarity are formed even on the sustain electrode lines Z. These excessive wall charges make the reset discharge unstable, which can generate an unstable discharge in subsequent sub-fields. Particularly, this problem is significant when a panel is driven at high temperature (approximately 40□ to 90□).

### SUMMARY OF THE INVENTION

Accordingly, an object of the present invention is to solve at least the problems and disadvantages of the background art.

An object of the present invention is to provide a method of driving a plasma display panel in which a stabilized discharge can be generated.

According to a first embodiment of the present invention, there is provided a method of driving a plasma display panel in which one frame includes a plurality of selective writing sub-fields and a plurality of selective erasing sub-fields, including the steps of applying a first erase ramp waveform to scan electrode lines during an erase period of at least one selective writing sub-field among the plurality of the selective writing sub-fields, for erasing wall charges generated by a discharge, and applying a second erase ramp waveform to sustain electrode lines alternately with the first erase ramp waveform during the erase period.

According to a second embodiment of the present invention, there is also provided a method of driving a plasma display panel, including the steps of applying a first erase ramp waveform to scan electrode lines during an erase period for erasing wall charges generated by a discharge, and applying a second erase ramp waveform to sustain electrode lines alternately with the first erase ramp waveform during the erase period.

According to the method of driving the PDP, wall charges can be erased sufficiently during the erase period of the selective writing sub-field. Therefore, a stabilize discharge can be generated in subsequent sub-fields. Particularly, a stabilized discharge can be generated at high temperature environment.

### BRIEF DESCRIPTION OF THE DRAWINGS

The invention will be described in detail with reference to the following drawings in which like numerals refer to like elements.

FIG. 1 is a perspective view illustrating the construction of a discharge cell of a three-electrode AC surface discharge type plasma display panel in a prior art.

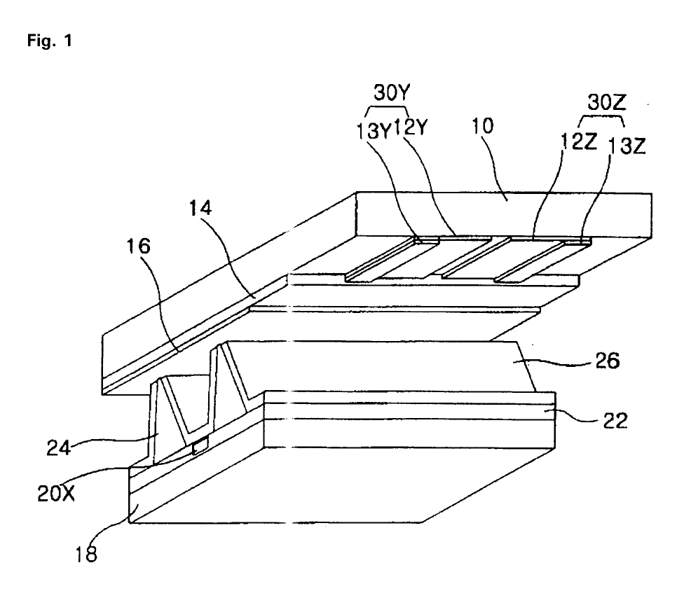

FIG. 2 shows a sub-field pattern of a frame period in a driving method of a plasma display panel in a prior art.

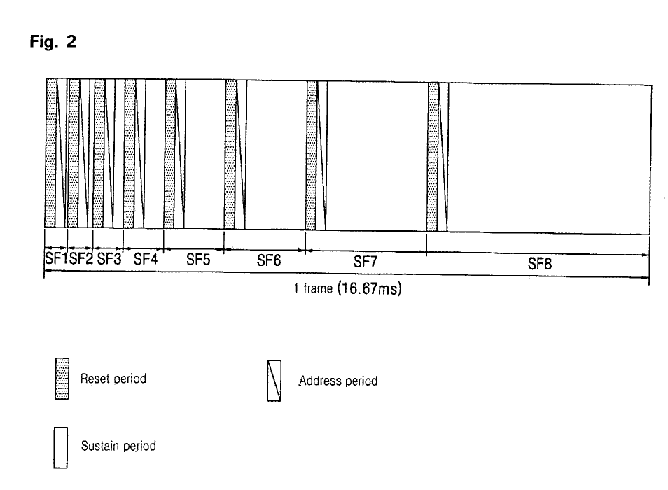

FIG. 3 shows a driving waveform of a plasma display panel that is driven in the SWSE mode in a prior art.

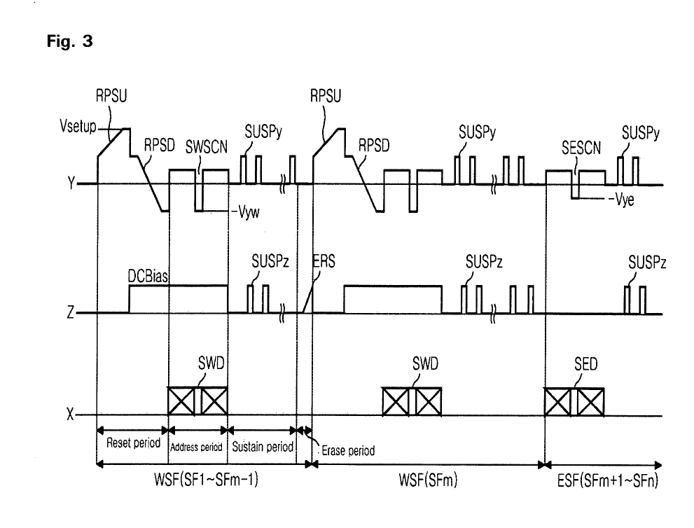

FIG. 4a shows wall charges formed by the last sustain pulse that is applied to the scan electrode lines in the driving waveform shown in FIG. 3.

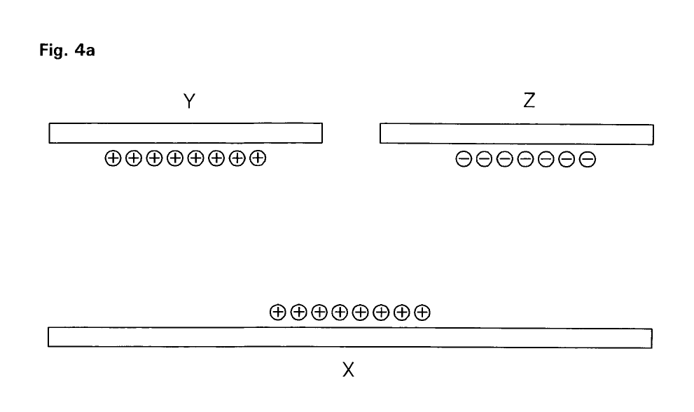

FIG. 4b shows wall charges that remain after being erased by the erase pulse applied to the sustain electrode lines during the erase period in the driving waveform shown in FIG. 3.

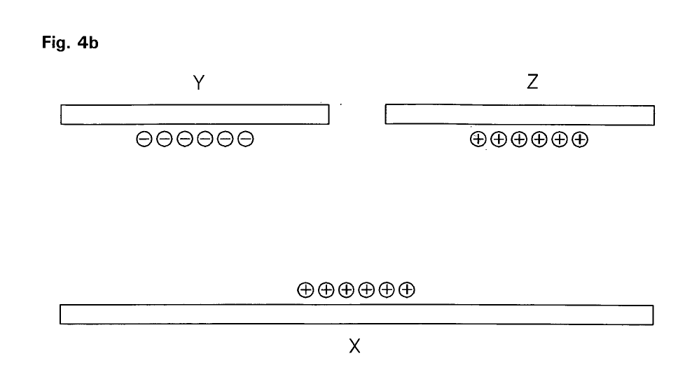

FIG. 5 shows a driving waveform of a plasma display panel according to an embodiment of the present invention.

FIG. 6 is a detailed view of an “A” portion in the driving waveform of FIG. 5.

FIG. 7a shows wall charges formed by the last sustain pulse that is applied to the sustain electrode lines in the driving waveform shown in FIG. 5.

FIG. 7b shows wall charges that remain after being erased by the first erase pulse applied to the scan electrode lines during the erase period in the driving waveform shown in FIG. 5.

FIG. 7c shows wall charges that remain after being erased by the second erase pulse applied to the sustain electrode lines during the erase period in the driving waveform shown in FIG. 5.

### DETAILED DESCRIPTION OF PREFERRED EMBODIMENTS

Preferred embodiments of the present invention will be described in a more detailed manner with reference to the drawings.

### First Embodiment

According to a first embodiment of the present invention, there is provided a method of driving a plasma display panel in which one frame includes a plurality of selective writing sub-fields and a plurality of selective erasing sub-fields, including the steps of applying a first erase ramp waveform to scan electrode lines during an erase period of at least one selective writing sub-field among the plurality of the selective writing sub-fields, for erasing wall charges generated by a discharge, and applying a second erase ramp waveform to sustain electrode lines alternately with the first erase ramp waveform during the erase period.

The at least one selective writing sub-field is located immediately before the last selective writing sub-field that is located before going over to the selective erasing sub-fields.

The at least one selective writing sub-field is a sub-field having 16 brightness weight.

The first erase ramp waveform is a ramp waveform in which a voltage gradually rises up to a first voltage and is then kept at the first voltage for a predetermined period.

The first voltage is set to approximately 200 to 300V.

The period where the first erase ramp waveform is supplied is set to approximately 80 to 150 μs.

The second erase ramp waveform is a ramp waveform in which a voltage gradually rises up to a predetermined voltage.

The period where the first erase ramp waveform is supplied is set to be longer than the period where the second erase ramp waveform is supplied.

The step of applying the first erase ramp waveform to the scan electrode lines during the erase period is applied when the panel is driven at high temperature.

The high temperature ranges from approximately 40 to 90.

Hereinafter, the method of driving a plasma display panel according to the first embodiment of the present invention will be described with drawings.

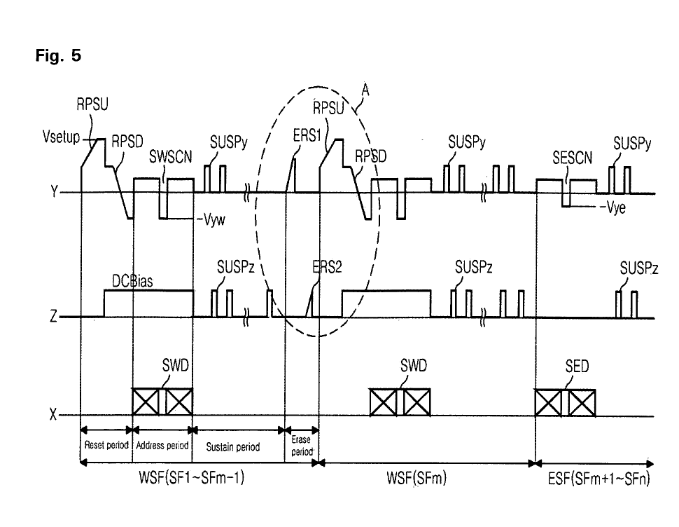

FIG. 5 shows a driving waveform of a plasma display panel according to an embodiment of the present invention.

Referring to FIG. 5, in a driving waveform of the PDP according to an embodiment of the present invention, one frame includes a selective writing sub-field WSF having one or more sub-fields, and a selective erasing sub-field ESF having one or more sub-fields.

The selective writing sub-field WSF includes a m number (where, m is a positive integer greater than 0) of sub-fields SF1 to SFm. Each of the first to (m−1)^{th} sub-fields SF1 to SFm−1 except for the m^{th} sub-field SFm is divided into a reset period for uniformly forming a constant amount of wall charges in cells of the entire screen, a selective writing address period for selecting on-cells using a write discharge, a sustain period for causing a sustain discharge to be generated in selected on-cells, and an erase period for erasing wall charges within cells after the sustain discharge. The m^{th} sub-field SFm being the last sub-field of the selective writing sub-field WSF is divided into a reset period, a writing address period and a sustain period.

In the reset period of the selective writing sub-field WSF, a ramp waveform RPSU of a rising tilt that rises up to a set-up voltage Vsetup is applied to all the scan electrode lines Y simultaneously. At the same time, a voltage of 0V or a ground voltage GND is applied to the sustain electrode lines Z and the address electrode lines X. The ramp-up waveform RPSU causes a dark discharge to be generated between the scan electrode lines Y and the address electrode lines X and between the scan electrode lines Y and the sustain electrode lines Z within the cells of the entire screen. Wall charges of the positive (+) polarity are accumulated on the address electrode lines X and the sustain electrode lines Z and wall charges of the negative (−) polarity are accumulated on the scan electrode lines Y, by means of the set-up discharge. After the ramp-up waveform RPSU, a ramp-down waveform RPSD of a falling tilt that starts to fall from a voltage of the positive polarity that is lower than the set-up voltage Vsetup is applied to the scan electrode lines Y. At the same time, a DC bias voltage Dcbias is applied to the sustain electrode lines Z. A dark discharge is generated between the scan electrode lines Y and the sustain electrode lines Z due to a voltage difference between the ramp-down waveform RPSD and the DC bias voltage DCbias. A dark discharge is also generated between the scan electrode lines Y and the address electrode lines X during a period where the ramp-down waveform RPSD drops. The set-down discharge by the ramp-down waveform RPSD serves to erase excessive wall charges that do not contribute to the address discharge among the charges generated by the ramp-up waveform RPSU. That is, the ramp-down waveform RPSD serves to set an initial condition of a stabilized write address.

In the writing address period of the selective writing sub-field WSF, a writing scan pulse SWSCN that drops up to a writing scan voltage −Vyw of the negative polarity is sequentially applied to the scan electrode lines Y. At the same time, a write data pulse SWD is applied to the address electrode lines X so that the writing scan pulse SWSCN is synchronized. As a voltage difference between the writing scan pulse SWSCN and the write data pulse SWD and a wall voltage accumulated previously within cells are added, a write discharge is generated in on-cells to which the write data pulse SWD is applied. The write discharge causes wall charges of the positive polarity to be accumulated on the scan electrode lines Y and wall charges of the negative polarity to be accumulated on the sustain electrode lines Z and the address electrode lines X. The wall charges formed thus serve to lower an external voltage for generating the sustain discharge during the sustain period, i.e., a sustain voltage.

In the sustain period of the selective writing sub-field WSF, sustain pulses SUSPy, SUSPz are alternately supplied to the scan electrode lines Y and the sustain electrode lines Z. Whenever the sustain pulses SUSPy, SUSPz are applied as such, a sustain discharge is generated in on-cells in which a write discharge is generated during the writing address period.

After the last sustain discharge is generated, during the erase period of the first to (m−2)^{th} sub-fields SF1 to SFm−2 of the selective writing sub-field WSF except for the last sub-field SFm, an erase ramp waveform ERS in which a voltage gradually rises up to the sustain voltage (Vs) is applied to the sustain electrode lines Z. The wall charges generated by the sustain discharge are erased by the erase ramp waveform ERS, while a weak erase discharge is generated in the on-cells. On the contrary, after the last sustain discharge is generated in the last sub-field SFm of the selective writing sub-field WSF, it is transferred to the first sub-field SFm+1 of the selective erasing sub-field ESF without any erase signal. Resultantly, the erase ramp waveform ERS or an erase voltage (or waveform) having this erase function is arranged in a corresponding sub-field only when a next sub-field is a selective writing sub-field.

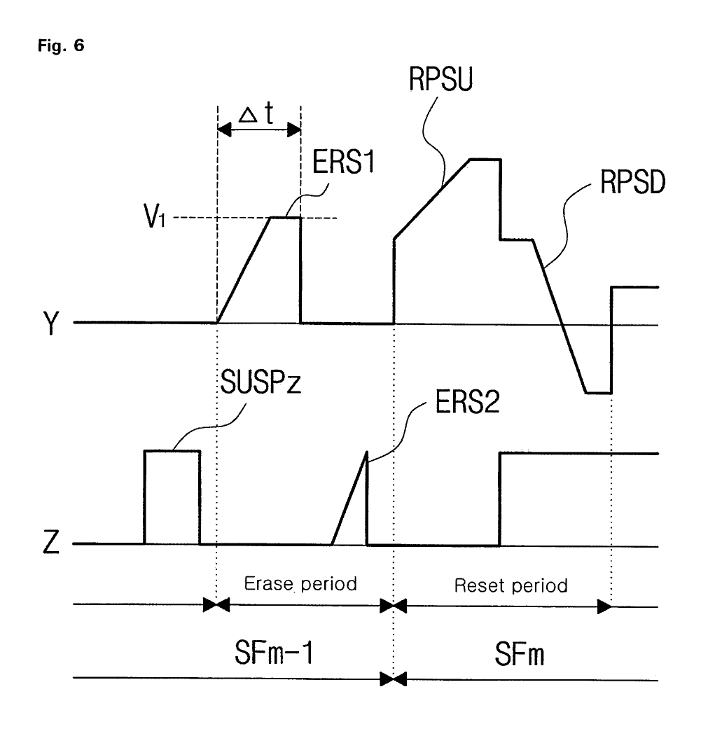

Meanwhile, in the (m−1)^{th} sub-field SFm−1, after the last sustain discharge is generated, a first erase ramp waveform ERS1 in which a voltage gradually rises up to a first voltage V1 as a predetermined voltage is applied and is then kept at the first voltage V1 for a given time, e.g., 20 μs, as shown in FIG. 6, is applied to the scan electrode lines Y during the erase period. In this time, it is preferred that the first voltage V1 ranges from 200V to 300V. This is for the erase discharge to occur properly. In this case, if the first voltage is less than 200V, the erase discharge is generated to some degree, but the erase discharge is not generated to a desired extent. Further, if the first voltage is higher than 300V, reverse charges are accumulated on the scan electrode lines Y due to too many erase discharges. Accordingly, a stabilized discharge is not generated in subsequent sub-fields.

Further, a period (t) in which the first erase ramp waveform ERS1 is supplied is preferably set to approximately 80 to 150 μs. This is for securing a sufficient erase discharge and a timing margin depending on the driving of a PDP. If the period where the first erase ramp waveform ERS1 is supplied is less than 80 μs, a sufficient voltage is not supplied since the supply period is too short. Therefore, an insufficient erase discharge is generated. Meanwhile, if the period in which the first erase ramp waveform ERS1 is supplied is greater than 150 μs, the timing margin depending on the driving of the PDP is reduced.

The wall charges generated by the sustain discharge are erased by the first erase ramp waveform ERS1, while a weak erase discharge is generated in on-cells. Also, during the erase period, a second erase ramp waveform ERS2 in which a voltage gradually rises up to the sustain voltage (Vs) is alternately supplied to the sustain electrode lines Z. In this time, the supply time of the second erase ramp waveform ERS2 is preferably shorter than that of the first erase ramp waveform ERS1. This is because the wall charges generated by the sustain discharge are sufficiently erased by the first erase ramp waveform ERS1, and the remaining wall charges can be erased although the second erase ramp waveform ERS2 is supplied for a period shorter than a period where the first erase ramp waveform ERS1 is supplied considering the timing margin depending on the driving of the PDP. That is, the remaining wall charges are further erased by the first erase pulse ERS1 while a weak erase discharge is generated in the on-cells by the second erase ramp waveform ERS2. Accordingly, a stabilized discharge can be generated in subsequent sub-fields.

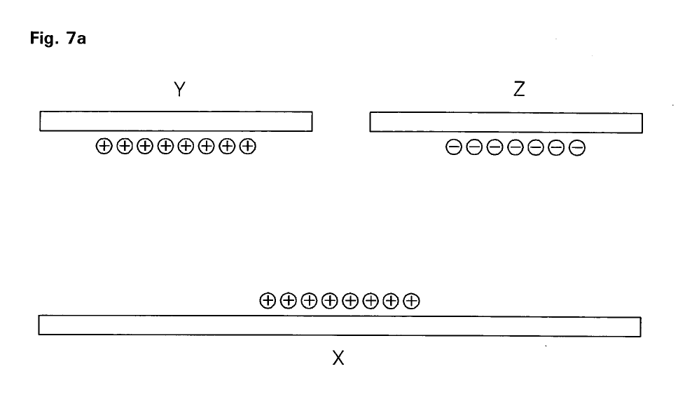

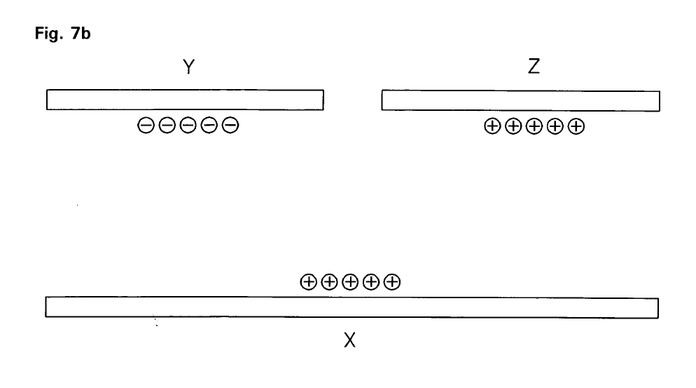

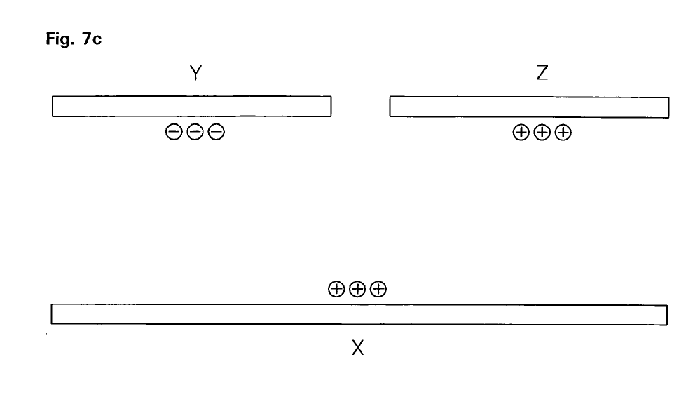

This will be now described in detail. If the last sustain pulse SUSPz is supplied to the sustain electrode lines Z of the (m−1)^{th} sub-field SFm−1, wall charges of the positive (+) polarity are formed in the scan electrode lines Y and wall charges of the negative (−) polarity are formed in the sustain electrode lines Z, as shown in FIG. 7a. Thereafter, during the erase period of the (m−1)^{th} sub-field SFm−1, the first erase ramp waveform ERS1 in which a voltage gradually rises up to a predetermined voltage and is then kept at the predetermined voltage for a given time is applied to the scan electrode lines Y. The wall charges generated by the sustain discharge as shown in FIG. 7a are erased by the first erase ramp waveform ERS1, while a weak erase discharge is generated in the on-cells. As a result, the wall charges are reduced, as shown in FIG. 7b. Further, during the erase period, the second erase ramp waveform ERS2 in which a voltage gradually rises up to the sustain voltage (Vs) is alternately supplied to the sustain electrode lines Z. The wall charges erased by the first erase ramp waveform ERS1 are erased by the second erase ramp waveform ERS2 again, while a weak erase discharge is generated in the on-cells. As a result, the wall charges are erased sufficiently, as shown in FIG. 7c. Accordingly, a stabilized discharge can be generated in subsequent sub-fields.

The selective erasing sub-field ESF includes an n-m number (where, n is a positive integer greater than m) of sub-fields SFm+1 to SFn. Each of the (m+1)th to n^{th} sub-fields SFm+1 to SFn is divided into an erase address period for selecting off-cells using an erase discharge, and a sustain period for generating a sustain discharge in on-cells.

In the address period of the selective erasing sub-field ESF, an erase writing scan pulse SESCN that drops up to an erase scan voltage −Vye of the negative polarity is sequentially applied to the scan electrode lines Y. At the same time, an erase data pulse SED synchronized with the erase scan pulse SESCN is applied to the address electrode lines X. As a voltage difference between the selective erase scan pulse SESCN of the negative polarity and the selective erase data pulse SWD and a wall voltage of on-cells which is kept from a previous sub-field are added, an erase discharge is generated in on-cells to which the selective erase data pulse SED is applied. The wall charges within the on-cells are erased by the erase discharge to the extent that a discharge is not generated although the sustain voltage is applied.

In the address period of the selective erasing sub-field SEF, a voltage of 0V or a ground voltage GND is applied to the sustain electrode lines Z.

In the sustain period of the selective erasing sub-field SEF, sustain pulses SUSPy, SUSPz are alternately applied to the scan electrode lines Y and the sustain electrode lines Z. Every when the sustain pulses SUSPy, SUSPz are applied as such, a sustain discharge is generated in on-cells in which an erase discharge is not generated in the erase address period.

Meanwhile, a data coding method for address in the driving method of the PDP that is driven in the SWSE mode will now be described. If it is assumed that one frame is composed of six selective writing sub-fields SF1 to SF6 whose brightness relative ratios are differently set to 2⁰, 2¹, 2², 2³, 2⁴ and 2⁵, respectively, and six selective erasing sub-fields SF7 to SF12 whose brightness relative ratios are set to 2⁵, the level of the gray scale that is represented by a combination of the sub-fields SF1 to SFn and a coding method can be expressed into the following Table 1.

TABLE 1

| Gray | SF1 | SF2 | SF3 | SF4 | SF5 | SF6 | SF7 | SF8 | SF9 | SF10 | SF11 | SF12 |
|---|---|---|---|---|---|---|---|---|---|---|---|---|
| Scale | (1) | (2) | (4) | (8) | (16) | (32) | (32) | (32) | (32) | (32) | (32) | (32) |

| | | | | | | | | |
|---|---|---|---|---|---|---|---|---|
| 0 31 | Binary coding | x | x | x | x | x | x | x |
| 32 63 | Binary coding | | x | x | x | x | x | x |
| 64 95 | Binary coding | | | x | x | x | x | x |
| 96 127 | Binary coding | | | | x | x | x | x |
| 128 159 | Binary coding | | | | | x | x | x |
| 160 | Binary coding | | | | | | x | x |
| 191 | | | | | | | | |
| 192 223 | Binary coding | | | | | | | x |
| 224 255 | Binary coding | | | | | | | |

As can be seen from Table 1, the first to fifth sub-fields SF1 to SF5 disposed in front of the frame represent gray scale values of cells through binary coding. Further, the sixth to twelfth sub-fields SF6 to SF12 decide brightness of a cell through linear coding over a given gray scale value to represent gray scale values. In this time, it was experimentally found that the driving waveform of the PDP driven in the SWSE mode according to an embodiment of the present invention can be better applied when the fifth sub-field SF5 being a sub-field immediately before the sixth sub-field SF6 of the last selective writing sub-field has 16 brightness weight.

In the method of driving the PDP according to the first embodiment of the present invention, the first erase ramp waveform ERS1 is applied to the scan electrode lines Y during the erase period of the selective writing sub-field SFm−1 right before the selective writing sub-field SFm which is a sub-field before going over from the selective writing sub-field WSF to the selective erasing sub-field ESF. Further, a second erase ramp waveform ERS2 is alternately applied to the sustain electrode lines Z. Accordingly, when the driving waveform according to the first embodiment of the present invention is applied to especially, high temperature environment, wall charges can be sufficiently erased during the erase period of the (m−1)^{th} selective writing sub-field SFm−1. Therefore, a discharge can be stably generated in subsequent sub-fields.

### Second Embodiment

According to a second embodiment of the present invention, there is also provided a method of driving a plasma display panel, including the steps of applying a first erase ramp waveform to scan electrode lines during an erase period for erasing wall charges generated by a discharge, and applying a second erase ramp waveform to sustain electrode lines alternately with the first erase ramp waveform during the erase period.

The first erase ramp waveform is a ramp waveform in which a voltage gradually rises up to a first voltage and is then kept at the first voltage for a predetermined period.

The first voltage is set to approximately 200 to 300V.

The period where the first erase ramp waveform is applied is set to approximately 80 to 150 μs.

The second erase ramp waveform is a ramp waveform in which a voltage gradually rises up to a predetermined voltage.

The period where the first erase ramp waveform is applied is set to be longer than the period where the second erase ramp waveform is applied.

The step of applying the first erase ramp waveform to the scan electrode lines during the erase period is applied when the panel is driven at high temperature.

The high temperature ranges from approximately 40 to 90.

Hereinafter, the method of driving a plasma display panel according to the second embodiment of the present invention will be described with drawings.

The driving method of the PDP according to the second embodiment of the present invention is different from those according to the first embodiment of the present invention in which one frame is driven with it being divided into the plurality of the selective writing sub-fields and the plurality of the selective erasing sub-fields in that one frame is driven with only a selective writing sub-field or a selective erasing sub-field. During the erase period of each of the selective writing sub-fields or the selective erasing sub-fields, however, the driving method of the PDP according to the second embodiment of the present invention is the same as those according to the first embodiment of the present invention.

In the driving method of the PDP according to the second embodiment of the present invention, wall charges can be erased sufficiently during the erase period of each of the sub-fields like the driving method of the PDP according to the first embodiment of the present invention. Accordingly, a discharge can be generated stably in subsequent sub-fields.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method of driving a plasma display panel in which one frame includes a plurality of selective writing sub-fields and a plurality of selective erasing sub-fields, comprising the steps of:
applying a first erase ramp waveform to scan electrode lines during an erase period of at least one selective writing sub-field among the plurality of the selective writing sub-fields, for erasing wall charges generated by a discharge; and
applying a second erase ramp waveform to sustain electrode lines alternately with the first erase ramp waveform during the erase period.

2. The method as claimed in claim 1, wherein the at least one selective writing sub-field is located immediately before the last selective writing sub-field that is located before going over to the selective erasing sub-fields.

3. The method as claimed in claim 2, wherein the at least one selective writing sub-field is a sub-field having 16 brightness weight.

4. The method as claimed in claim 1, wherein the first erase ramp waveform is a ramp waveform in which a voltage gradually rises up to a first voltage and is then kept at the first voltage for a predetermined period.

5. The method as claimed in claim 4, wherein the first voltage is set to approximately 200 to 300V.

6. The method as claimed in claim 4, wherein the period where the first erase ramp waveform is supplied is set to approximately 80 to 150 μs.

7. The method as claimed in claim 1, wherein the second erase ramp waveform is a ramp waveform in which a voltage gradually rises up to a predetermined voltage.

8. The method as claimed in claim 1, wherein the period where the first erase ramp waveform is supplied is set to be longer than the period where the second erase ramp waveform is supplied.

9. The method as claimed in claim 1, wherein the step of applying the first erase ramp waveform to the scan electrode lines during the erase period is applied when the panel is driven at high temperature.

10. The method as claimed in claim 9, wherein the high temperature ranges from approximately 40 to 90.

11. A method of driving a plasma display panel, comprising the steps of:
applying a first erase ramp waveform to scan electrode lines during an erase period for erasing wall charges generated by a discharge; and
applying a second erase ramp waveform to sustain electrode lines alternately with the first erase ramp waveform during the erase period.

12. The method as claimed in claim 11, wherein the first erase ramp waveform is a ramp waveform in which a voltage gradually rises up to a first voltage and is then kept at the first voltage for a predetermined period.

13. The method as claimed in claim 12, wherein the first voltage is set to approximately 200 to 300V.

14. The method as claimed in claim 12, wherein the period where the first erase ramp waveform is applied is set to approximately 80 to 150 μs.

15. The method as claimed in claim 11, wherein the second erase ramp waveform is a ramp waveform in which a voltage gradually rises up to a predetermined voltage.

16. The method as claimed in claim 11, wherein the period where the first erase ramp waveform is applied is set to be longer than the period where the second erase ramp waveform is applied.

17. The method as claimed in claim 11, wherein the step of applying the first erase ramp waveform to the scan electrode lines during the erase period is applied when the panel is driven at high temperature.

18. The method as claimed in claim 17, wherein the high temperature ranges from approximately 40 to 90.
